(19) United States
(12) Patent Application Publication
(10) Pub. No.: US 2026/0186704 A1
(43) Pub. Date: Jul. 2, 2026

(54) DIRECT TRANSFER BETWEEN INTERNAL MEMORY AND EXTERNAL MEMORY

(71) Applicant: Micron Technology, Inc., Boise, ID (US)

(72) Inventors: Jeffrey S. McNeil, Boise, ID (US); Eric N. Lee, San Jose, CA (US); Xiangyu Tang, San Jose, CA (US); Suresh Rajgopal, San Diego, CA (US); Sundararajan Sankaranarayanan, Fremont, CA (US); Akira Goda, Tokyo (JP)

(21) Appl. No.: 19/434,428

(22) Filed: Dec. 29, 2025

Related U.S. Application Data
(60) Provisional application No. 63/740,397, filed on Dec. 31, 2024.
(60) Provisional application No. 63/740,399, filed on Dec. 31, 2024.
(60) Provisional application No. 63/782,779, filed on Apr. 3, 2025.

(51) Int. Cl. G06F 3/06

(52) U.S. Cl. CPC G06F 3/0658; G06F 3/061; G06F 3/068

(57) ABSTRACT

A device includes non-volatile memory dies, a memory controller coupled to the non-volatile memory dies, a processing unit coupled to the memory controller and the non-volatile memory dies, and an external interface coupled, via a multiplexer controlled by the processing unit, to the non-volatile memory dies. The processing unit is configured to perform operations including: selecting, by the multiplexer, a first non-volatile memory die, causing the memory controller to read a data item from the first non-volatile memory die, and causing the data item to be transmitted via the external interface.

### CLAIM OF PRIORITY

The present application claims the benefit under 35 U.S.C. § 119(e) of U.S. Provisional Patent Application No. 63/782,779 filed Apr. 3, 2025, U.S. Provisional Patent Application No. 63/740,397 , filed Dec. 31, 2024 and U.S. Provisional Patent Application No. 63/740,399, filed Dec. 31, 2025, all of which are incorporated by reference herein.

### TECHNICAL FIELD

Implementations of the disclosure relate generally to compute devices, and more specifically, relate to direct transfer between internal memory and external memory.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The present disclosure will be understood more fully from the detailed description given below and from the accompanying drawings of various implementations of the disclosure.

FIG. 1 is an example system employing a compute device having a hybrid on-chip cache (e.g., with combined volatile memory (VM) and NVM dies) on a processing die according to some embodiments.

FIG. 2 is an example system for direct transfer between internal memory and external memory, according to some aspects of the disclosure.

FIG. 3 is a flow chart of an example method for performing direct transfer between internal memory and external memory according to some aspects of the disclosure.

FIG. 4A is a flow chart of an example method for performing direct transfer between internal memory and external memory according to some aspects of the disclosure.

FIG. 4B is a flow chart of an example method for performing direct transfer between internal memory and external memory according to some aspects of the disclosure.

FIG. 4C is a flow chart of an example method for performing direct transfer between internal memory and external memory according to some aspects of the disclosure.

FIG. 4D is a flow chart of an example method for performing direct transfer between internal memory and external memory according to some aspects of the disclosure.

FIGS. 5A-5B show example high-level component diagrams of hybrid NVM/HBM devices implemented in accordance with aspects of the present disclosure.

FIG. 6 schematically illustrates example logical and physical address spaces of the hybrid NVM/HBM devices implemented in accordance with aspects of the present disclosure.

FIG. 7 illustrates an example computing system that includes a memory sub-system implemented in accordance with some implementations of the present disclosure.

FIG. 8 is a block diagram illustrating a system for performing AI model inference operations using memory devices and/or host systems implemented in accordance with aspects of the present disclosure.

FIG. 9 is a block diagram of an example computer system in which implementations of the present disclosure may operate.

### DETAILED DESCRIPTION

Aspects of the present disclosure are directed to direct transfer between internal memory and external memory. A memory sub-system can include one or more storage devices, memory modules, and/or hybrid storage devices and memory modules. Examples of storage devices and memory modules are described below. In general, a host system can utilize a memory sub-system that includes one or more components, such as memory devices that store data. The host system can provide data to be stored at the memory sub-system and can request data to be retrieved from the memory sub-system.

A memory sub-system may utilize one or more memory devices, including any combination of the different types of non-volatile memory devices and/or volatile memory devices, to store the data provided by the host system. In some implementations, non-volatile memory devices may be provided by negative-and (NAND) type flash memory devices. A non-volatile memory device is a package of one or more dies. Each die (“logical unit”) may include one or more planes. For some types of non-volatile memory devices (e.g., NAND devices), each plane may include a set of physical blocks. Each block may in turn include a set of pages. Each page includes a set of memory cells. A memory cell is an electronic circuit that stores one or more bits of information.

A memory device may include multiple memory cells arranged in a two-dimensional grid. The memory cells can be formed onto a silicon wafer in an array of columns and rows. A memory cell includes a capacitor that holds an electric charge and a transistor that acts as a switch controlling access to the capacitor. Accordingly, the memory cell may be programmed (written to) by applying a certain voltage, which results in an electric charge being held by the capacitor. The memory cells are joined by wordlines, which are conducting lines electrically connected to the control gates of the memory cells, and bitlines, which are conducting lines electrically connected to the drain electrodes of the memory cells.

Depending on the cell type, each memory cell may store one or more bits of information and has various logic states that correlate to the number of bits being stored. The logic states may be represented by binary values, such as “0” and “1”, or combinations of such values. A memory cell may be programmed (written to) by applying a certain voltage to the memory cell, which results in an electric charge being held by the memory cell, thus allowing modulation of the voltage distributions produced by the memory cell. A set of memory cells referred to as a memory page may be programmed together in a single operation, e.g., by selecting consecutive bitlines.

Precisely controlling the amount of the electric charge stored by the memory cell allows establishing multiple logical levels, thus effectively allowing a single memory cell to store multiple bits of information. A read operation may be performed by comparing the measured threshold voltages (Vt) exhibited by the memory cell to one or more reference voltage levels in order to distinguish between two logical levels for single-level cell (SLCs) and between multiple logical levels for multi-level cells. Each logical level may be translated into a corresponding binary representation of the content of the memory cell.

Memory access operations (e.g., a read operation, a programming (write) operation, an erase operation, etc.) may be executed with respect to sets of the memory cells, e.g., in response to receiving memory access commands from the host. A memory access operation may specify the requested memory access operation (e.g., write, erase, read, etc.) and a logical address, which the memory sub-system would translate to a physical address identifying a set of memory cells (e.g., a block).

In some implementations, memory sub-systems can be used to store data used to train machine learning (ML) and artificial intelligence (AI) frameworks, as well as data on which the ML/AI framework can be executed. An ML/AI framework can include a model, which is a representation of a neural network designed to produce one or more outputs responsive to one or more inputs. In such frameworks, the amount of data used to train the ML models can be extremely large and a training process cycle can be executed multiple times (e.g., multiple “epochs”). For example, an ML framework used to classify an image as being a particular type of image (e.g., an image of a person, an animal, a type of animal, etc.) can utilize a large data set of stored images that are repeatedly processed in multiple epoch cycles to train the model. Similarly, data sets used for testing and/or inference stages of a ML/AI workflow can include very large amounts of data. For example, the inference stage utilizes the trained model, which is very large and requires significant storage, to make predictions or decisions on new input data. This process can include processing the input data, feeding it into the model, and post-processing the output of the model if necessary.

In order to process the large amounts of data, many host systems executing ML/AI frameworks include multiple processing units or compute devices (e.g., graphics processing units (GPUs) and/or central processing units (CPU)) which can process multiple threads/streams in parallel. During the inference phase, these processing units utilize relatively small chunks of data (e.g., tens or hundreds of bytes) from a significantly larger corpus of data (e.g., many gigabytes or terabytes) stored at a memory sub-system. For example, the inference phase may involve walking through multiple graph nodes in order to determine the value of a vertex element and identify its connections.

In some implementations, the input data can be loaded from the memory sub-system to a local host memory co-located with the processing units executing the ML/AI framework. This host memory can be implemented using high-bandwidth memory (HBM) devices that offer extremely high (i.e., fast) performance, but have relatively low storage capacities.

In some implementations, multiple processing units or compute devices (GPUs and/or CPUs) can be connected to a shared memory pool, such that each processing unit can have its own local memory and can also access, over a high-speed interconnect, the memory that is local to other processing units. However, the local memory accesses would exhibit much lower latency as compared to the remote memory accesses.

Thus, the memory capacity is one of the biggest challenges faced by enterprise deployment of AI/ML models. Various solutions involve increasing the number of dies stacked in HBM packages accessible by a processing unit or compute device (e.g., a GPU) and implementing various non-uniform memory access (NUMA) schemes in which a processing unit, in addition to its local memory, may also access a local memory of another processing unit. However, these and other solutions fail to adequately satisfy the growing memory capacity requirements while delivering the requisite memory access bandwidth and latency, not to mention containing the costs.

Aspects of the present disclosure address the above and other deficiencies by integrating non-volatile memory (NVM) dies (e.g., NAND) with volatile memory (VM) dies (e.g., HBM dies) as on-chip cache within a single hybrid compute device, e.g., an integrated circuit (IC) on a common package substrate of a GPU or CPU. Thus, in some embodiments, the hybrid compute device is or includes a processing unit such as a GPU or CPU, thus affording increased memory capacity on the same package as a compute die, reducing the need for off-package data movement operations between the memory dies because the VM/NVM dies are locally accessible by the compute die. Further, by storing the most-frequently accessed data in the VM or HBM dies, a higher number of hits at the faster memory can be realized due to more predictable, repetitive compute operations performed in AI/ML frameworks. In the case of a miss at the HBM dies, internal memory control can be configured to retrieve the data from the NVM dies and store the data in the HBM dies. In this way, the VM or HBM dies can operate as a type of first-level cache while the NVM dies can operate as a second-level cache, both on-die of the compute device and operating transparently to the compute die.

In illustrative embodiments, the hybrid compute device includes, in addition to the compute die, one or more one NVM dies, one or more HBM dies, and a logic die on which a local memory controller can reside. The local memory controller can perform the address translation and other local memory management tasks, which will be discussed in more detail. In some embodiments, the hybrid compute device includes one or more compute dies on which one or more processing units (GPUs and/or CPUs) reside.

The compute device can receive a request from an external system to access data stored to one or more internal memory dies. In some implementations, this external request is processed by the compute die. That is, the compute die receives the external request and then requests the data at the respective internal memory die. The memory die provides the requested data back to the compute die. The compute die repackages the requested data as necessary and provides the requested data back to the external system that requested the data. This approach causes the transfer of data from internal memory dies to external systems to be entirely dependent on the processing availability of the compute die. For example, if the compute die is processing a workload at maximum capacity, the transfer of data from the internal memory die to the external system may be deprioritized, which can increase the read latency for reading data off of the internal memory die.

Aspects of the present disclosure address the above and other deficiencies using direct transfer between internal memory and external memory. A computing device, such as a GPU can include a compute die, one or more memory dies, a multiplexer, and an external interface. The GPU receives and processes requests at the compute die, which is connected to each memory die. The external interface is also connected to each memory die via the multiplexer. When the compute die receives a request to read data from one of the internal memory dies, the compute die instructs the memory die (e.g., via a memory controller) to provide the requested data to the external interface via the multiplexer. The compute die sends a select signal to the multiplexer that indicates which memory die is to provide the data to respond to the request. The external interface is connected to an external system. When the compute die instructs the memory die to provide the requested data to the external interface, the compute die also instructs the multiplexer to enable a connection between the particular memory die and the external interface. For example, the compute die can send a select signal to a multiplexer that has inputs from various internal memory dies. The select signal can cause the multiplexer to connect the internal memory die containing the requested data to the external interface, and thus the requested data can be provided to the external system via the external interface. In this way, the compute die identifies a data location and enables the transfer of the data (e.g., through the select signal) but does not have to process receiving the read data from the memory die and providing the read data to the external system.

These and other advantages of the approaches described herein include the improved performance of memory devices and subsystems, which may be particularly beneficial when used in ML/AI frameworks, and will be described in more detail herein below. For example, AI/ML training and inference phases may be limited by the speed at which data can be transferred from internal memory dies of a computing device (e.g., a GPU) to an external system. Decreasing the processing resources used to provide the data to the external system can increase the availability of processing resources (e.g., of the compute die) to perform other operations, thus improving performance of the computing device. Additionally, the speed at which data is transferred from the internal memory dies to the external system is no longer limited by the availability of the compute die, which can reduce the latency of external read requests, leading to improved performance of systems that include the computing device and the external system (e.g., such as a memory sub-system, etc.).

In this way, the compute die can initially receive a request for data from one of the internal memory dies and after identifying that the request for data was made, the compute die can offload the actual processing of the request to a memory die that stores the data (e.g., a memory controller connected to the memory die). This can reduce the processing performed by the compute die as well as reduce the amount of data transferred via the direct connection from external system components to the compute die, thus improving the bandwidth of the memory device.

In some implementations, one or more hybrid compute devices implemented in accordance with one or more aspects of the present disclosure may be packaged into a specified form factor, e.g., a form factor utilized by non-volatile memory devices, a form factor utilized by storage devices (such as solid state drives (SSDs)), or the like. Using a standard memory form factor would facilitate seamless integration of the device into various computing systems, such as, e.g., Internet-of-Things (IoT) devices, wearable or portable computing devices, automotive computing devices, enterprise compute systems, or enterprise storage systems, etc.

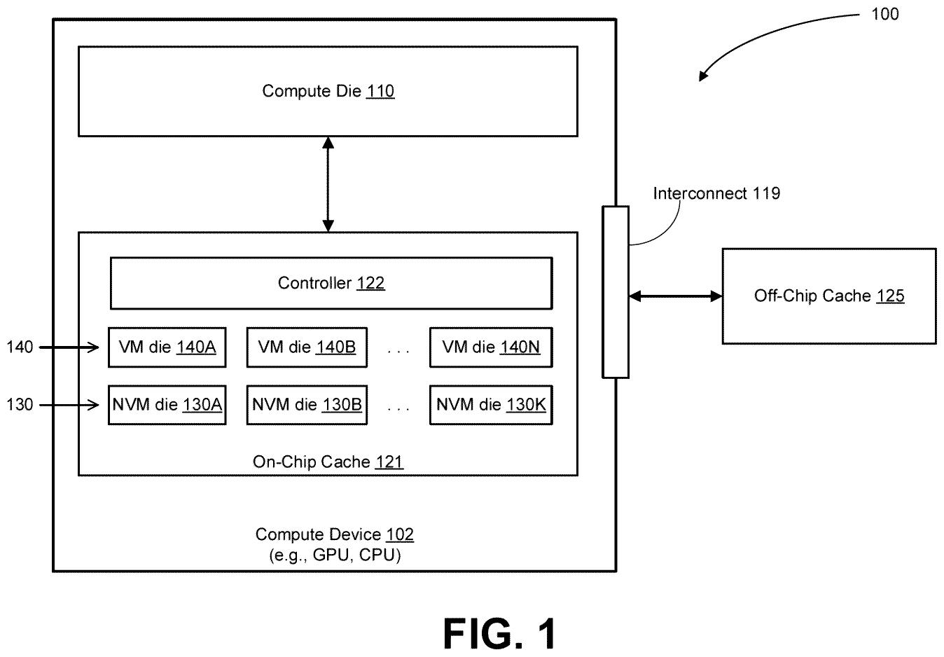

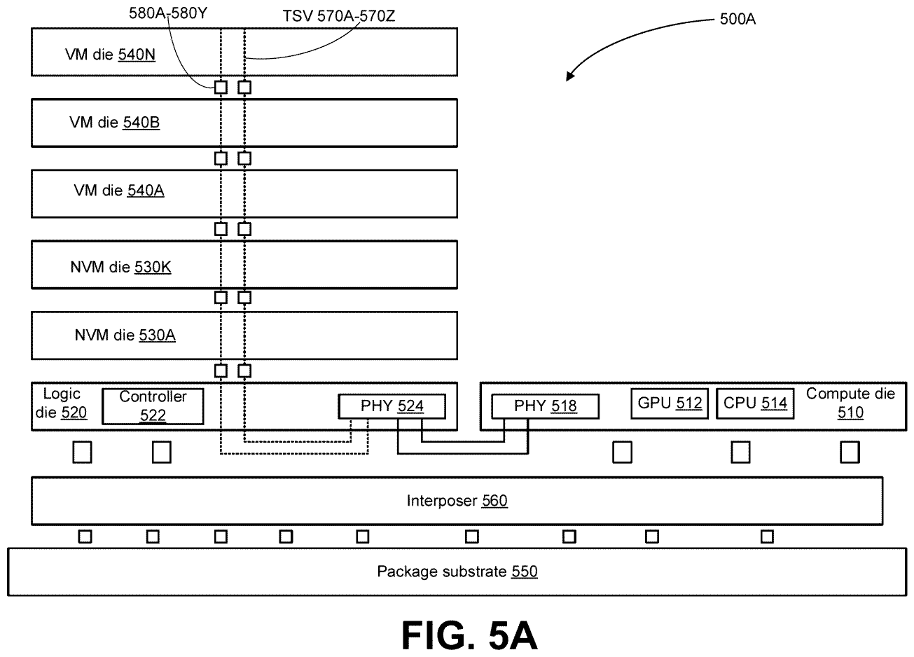

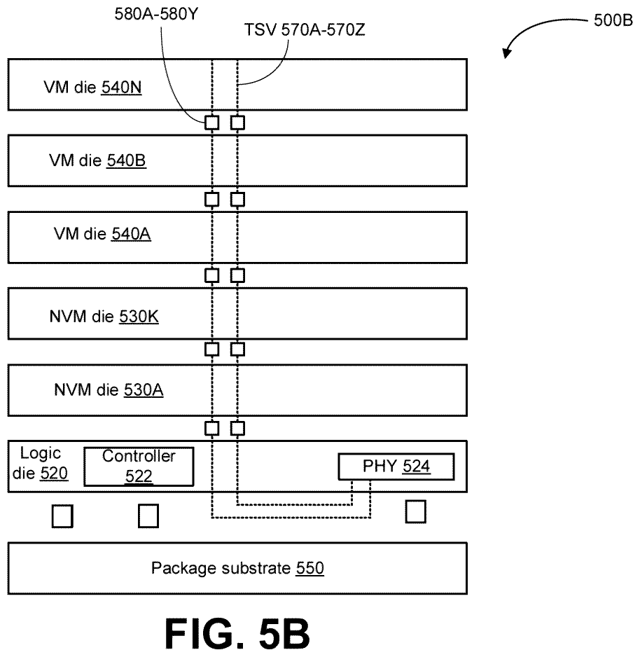

FIG. 1 is an example system 100 employing a compute device 102 having a hybrid on-chip cache 121 (e.g., combined VM and NVM dies) on a processing die according to some embodiments. The compute device 102 can include memory and compute components disposed on a common package substrate (see FIGS. 5A-5B). The system 100 can further include an interconnect 119 disposed on the package substrate and coupled to a off-chip cache 125 that is disposed off of the package substrate. In an embodiment, the interconnect 119 is a Peripheral Component Interconnect Express (PCIe) or other high-speed interface that connects components of a printed circuit board, e.g., like graphics cards, hard drives, and network adapters.

In some embodiments, the compute device 102 includes a compute die 110 disposed on the package substrate and the on-chip cache 121 disposed on the package substrate and coupled to the compute die 110. In embodiments, the on-chip cache 121 includes one or more volatile memory dies (e.g., VM dies 140, which can operate as a first-level cache) and one or more non-volatile memory dies (e.g., NVM dies 130, which can operate as a second-level cache). For example, the VM dies 140 can include a first VM die 140A, a second VM die 140B, through to an Nth VM die 140N, which can be DRAM, but for higher speed modern compute devices, may be HBM dies. Further, the NVM dies 130 can include a first NVM die 130A, a second NVM die 130B, through to a Kth NVM die 130K, which can be, for example, NAND dies or flash-based memory dies.

In some embodiments, the compute device 102 includes a memory controller 122, disposed on the package substrate, and coupled between the compute die 110 and the on-chip cache 121. Thus, the memory controller 122 can be located as part of the on-chip cache 121 or as stand-alone processing logic on a logic die (see FIGS. 5A-5B). In at least some embodiments, the memory controller 122 is configured to make management of the on-chip cache 121 transparent to the compute die 110.

For example, the memory controller 122 can make the combination of the VM dies 140 and the NVM dies 130 appear as uniform cache and manage address translations, compensation for delay between access speeds of VM dies compared to NVM dies, and other media management associated with the on-chip cache 121. The memory controller 122 can balance data-storing workloads across the VM dies 140 and the NVM dies 130, manage the NVM dies 130 for garbage collection and data integrity, and conduct caching and prefetching operations as between the VM dies 140 and the NVM dies 130, the latter of which will be described in more detail. In embodiments of balancing data storage, the data stored in the NVM dies 130 can be preemptively copied to the NVM dies 140 for faster access according a loading scheme and following various caching algorithms, which will be discussed.

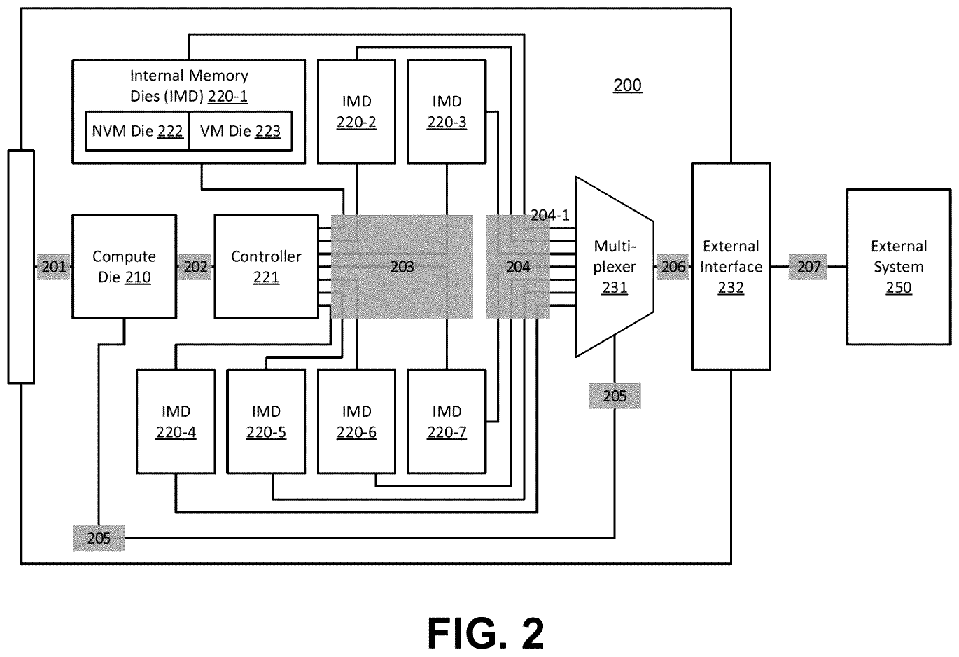

FIG. 2 is an example system 200 for direct transfer between internal memory and external memory, according to some aspects of the disclosure.

System 200 includes a compute die 210, one or more internal memory dies 220 (illustrated here as internal memory die 220-1, and IMMs 220-2, 220-3, 220-4, 220-5, 220-6, 220-7), a multiplexer 231 and a external interface 232.external interface The system 200 is connected to an external system 250. The controller 221 can manage the internal memory dies 220. Each internal memory die 220 includes one or more NVM dies 222 and one or more VM dies 223, as is similarly described with reference to FIG. 1. In some embodiments, the functionality of the controller 221 can be performed by processing hardware in each of the internal memory dies 220. That is, in some embodiments, each internal memory die may include a respective controller.

For an initial request for data stored at an internal memory die 220, the compute die 210 receives requests from external systems via the connection 201. The compute die 210 can process the received request. In some embodiments, the compute die 210 can transmit instructions to the one or more internal memory dies 220 and/or the external interface 232 based on the requests received via the connection 201. After the initial request for the data stored at an internal memory die 220, subsequent processing operations to obtain the data from the particular internal memory die may be processed by the controller 221 and/or at the particular internal memory die. This is enabled by the compute die 210 sending the appropriate control signal to the multiplexer 231 that enables the external system (e.g., external system 250) to connect directly to the particular internal memory die, as is further described herein.

The compute die 210 is connected to the controller 221 by a second connection 202. The controller 221 is connected to the one or more internal memory dies 220 by third connections 203. The compute die 210 accesses the one or more internal memory dies 220 via the controller 221. For example, the compute die 210 can read data from the one or more internal memory dies 220 via the second connection 202 to the controller 221, which obtains the data from the internal memory dies 220 via the third connections 203. In another example, the compute die 210 can send data to the one or more internal memory dies 220 via the controller 221 (e.g., using the second connection 202) and the controller 221 can write the data sent by the compute die 210 to the internal memory dies 220 via the third connections 203.

The compute die 210 is connected to the multiplexer 231 by fifth connection 205 external interface. In some embodiments, the compute die 210 can transmit a control signal to the multiplexer 231 via the fifth connection 205. The control signal can indicate which internal memory die 220 that is providing data to an external system. In some embodiments, the control signal is a select signal for a multiplexer. Notably, the information sent by the compute die 210 to the multiplexer 231 does not include read data from the one or more internal memory dies 220. external interface

The multiplexer 231 can receive inputs from each of the internal memory dies 220 via fourth connections 204. The multiplexer 231 can receive a control signal as the fifth connection 205. The multiplexer 231 can enable memory inputs (e.g., via fourth connections 204) to be processed by the external interface 232 via the connection 206, based on the input selected by the fifth connection 205 (e.g., the select input connection). For example, the data received at the memory input 204-1 can be processed by the external interface 232 when the control signal at the fifth connection 205 enables the memory input 204-1. In some embodiments, enabling one of the fourth connections 204 causes the remaining fourth connections 204 to be disabled, thus only permitting data from one of the fourth connections 204 to be processed. In alternative embodiments, the multiplexer 231 can be configured to allow for data from multiple fourth connections 204 to be processed simultaneously, based on a control signal received at the connection 205. In some embodiments, the multiplexer 231. In some embodiments, the multiplexer 231 can receive multiple control signals via the connection 205.

The external interface 232 enables a data-transfer connection of the system 200 with an external system 250 via connection 207, such as an external storage device (e.g., external memory sub-system). In some embodiments, the external interface 232 can prepare the data received through the multiplexer 231 to be provided to the external system 250. In some embodiments, the preparation of the data is based on one or more communication standards such as: peripheral component interconnect express (PCIe), compute express link (CXL), serial advanced technology attachment (SATA), non-volatile memory express (NVMe), universal flash storage (UFS), embedded multimedia card (eMMC), universal serial bus (USB), ethernet, Nvidia Link (NVLink), or the like. In some embodiments, the physical structure of the external interface 232 is based on the selected communication standard.

In some embodiments, the external interface 232 can further transform the data received from the multiplexer 231. For example, the external interface 232 can include one or more processing devices that reformat the data from a particular data type used by the compute device (as described above) into another data type used by the external system.

The one or more internal memory dies 220 include respective non-volatile memory dies (e.g., NVM dies 222), and respective volatile memory dies (e.g., VM dies 223). A central memory controller (e.g., the controller 221) can be connect the internal memory dies 220 to the compute die 210. When data from one of the internal memory dies 220 is initially requested from the system 200 via the connection 201 to the compute die 210, the compute die 210 forwards the request to the controller 221. The controller 221 receives an access request from the compute die 210 via the second connection 202. The controller 221 processes the access request, and provides the data requested by the compute die 210 to the external interface 232, via the third connections 203, thus bypassing the compute die 210 and the first connection 201. This frees up bandwidth of the first connection 201 and processing resources of the compute die 210. For example, the controller 221 receives a read request from the compute die 210. The controller 221 processes the read request by accessing the data for the read request from the respective memory die(s) and providing the data to the external interface 232 via the third connections 203.

In some embodiments, data saved to the one or more internal memory dies 220 can be saved with a particular formatting for the computing device. For example, a computing die 210 can format data written to the internal memory dies 220 in a way that is optimized for processing the data by the computing die 210. In some embodiments, the controller 221 of an internal memory die 220 provides the data with the particular formatting to the external interface 232. The external interface 232 can provide the data with the particular formatting to an external system without modifying the data formatting. Additional details regarding the external interface 232 are described below with reference to FIG. 2B.

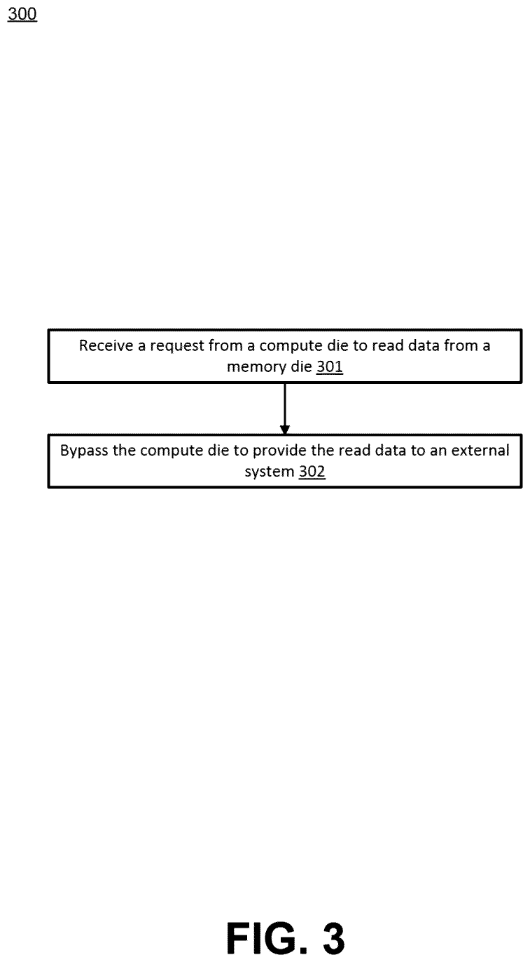

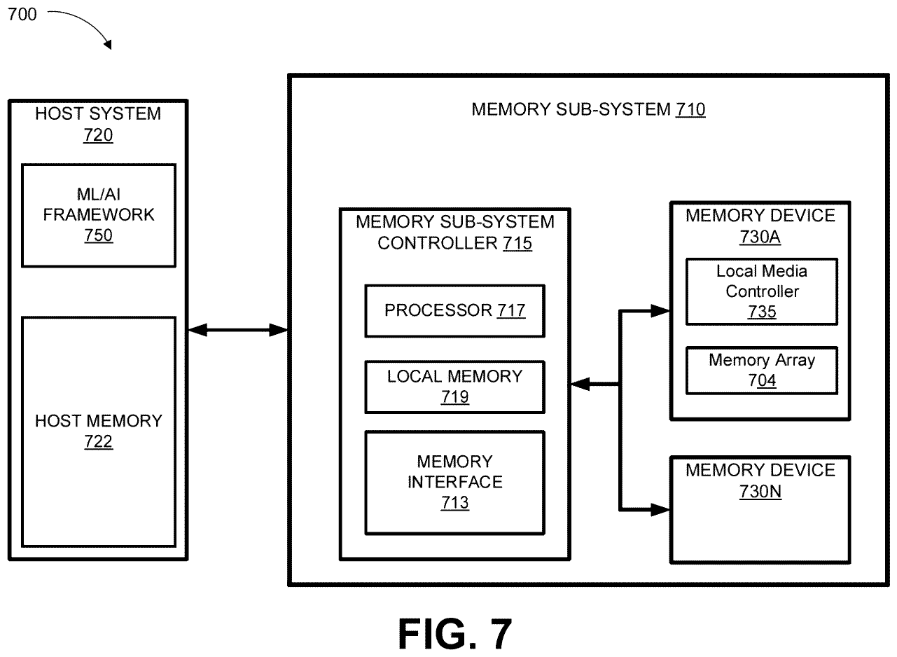

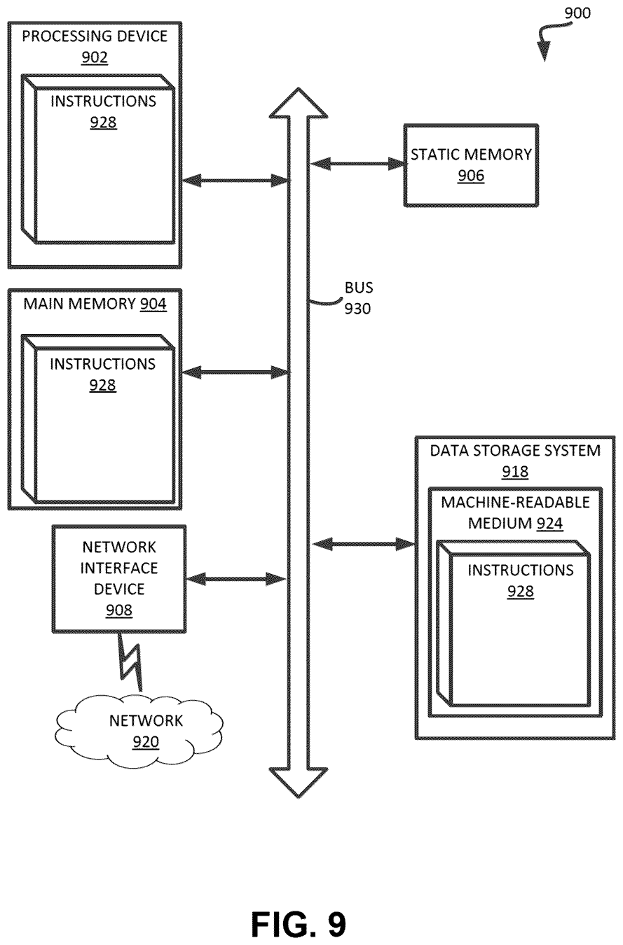

FIG. 3 is a flow chart of an example method 300 for performing direct transfer between internal memory and external memory according to some aspects of the disclosure. The method 300 may be performed by processing logic that may include hardware (e.g., one or more processing device(s), circuitry, dedicated logic, programmable logic, microcode, hardware of a device, integrated circuit, etc.), software (e.g., instructions run or executed on a processing device), or a combination thereof. In an illustrative example, the method 300 is performed by the controller 122 of FIG. 1 and/or the controller 221 of FIG. 2. In another illustrative example, the method 300 is performed by the memory sub-system controller 715 of FIG. 7. In another illustrative example, the method 300 is performed by the processing device 902 of FIG. 9. Although shown in a particular sequence or order, unless otherwise specified, the order of the operations may be modified. Thus, the illustrated implementations should be understood only as examples, and the illustrated operations may be performed in a different order, while some operations may be performed in parallel. Additionally, one or more operations may be omitted in some implementations. Thus, not all illustrated operations are required in every implementation, and other process flows are possible.

At operation 301, the controller performing the method 300 receives a request from a compute die to read data from a memory die.

At operation 302, the controller bypasses the compute die to provide the read data to an external system. In some embodiments, the request can originate from an external system that will be receiving the data. That is, an external system requests the data via the compute die and the external system receives the requested data via a connection that bypasses the compute die. In some embodiments, the request can originate from a system that will not be receiving the data. That is, a master system controller can request, via the compute die, that data be sent to an external system or component, and the external system receives the requested data via a connection that bypasses the compute die.

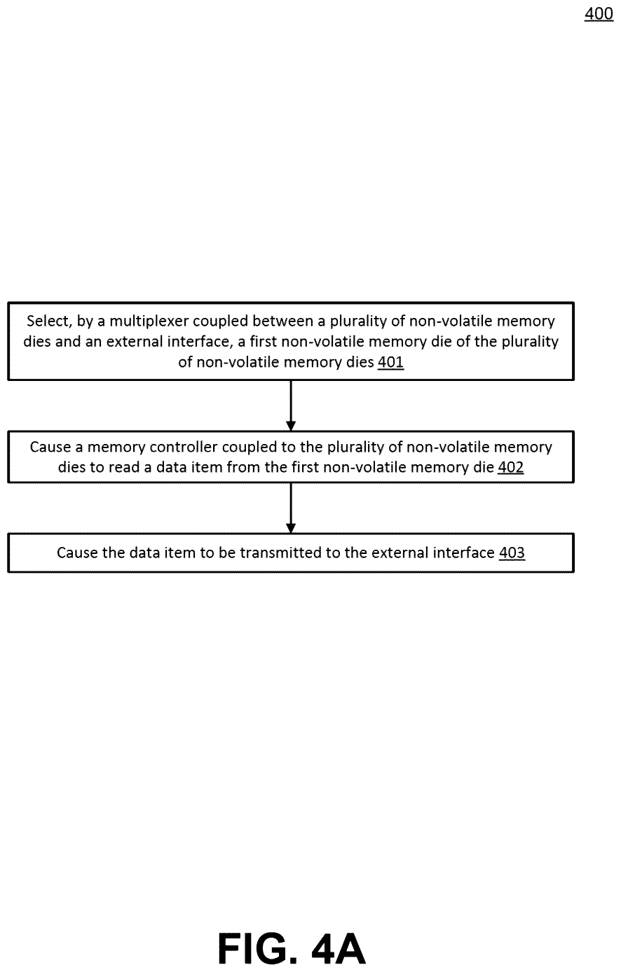

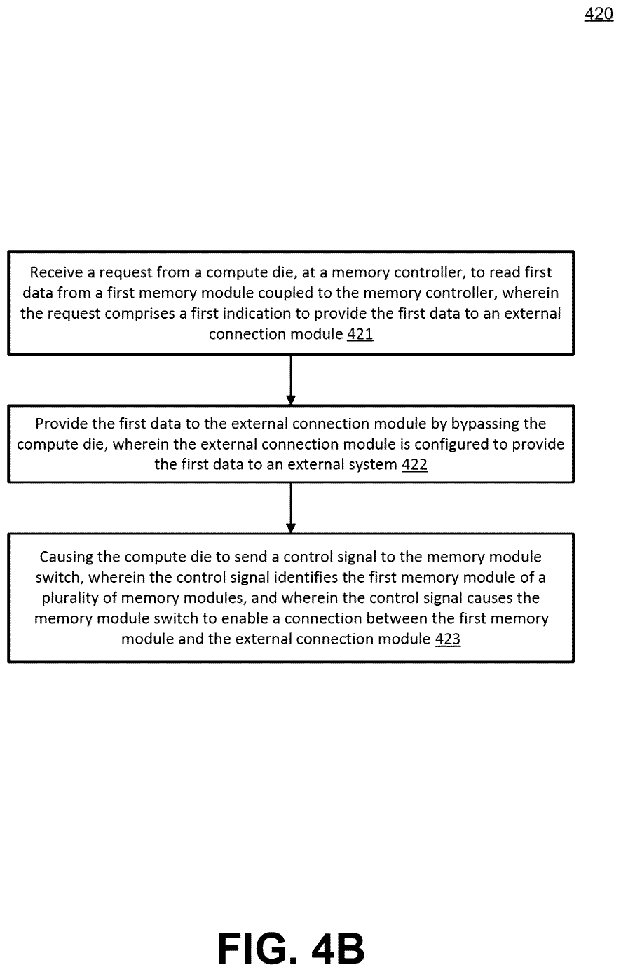

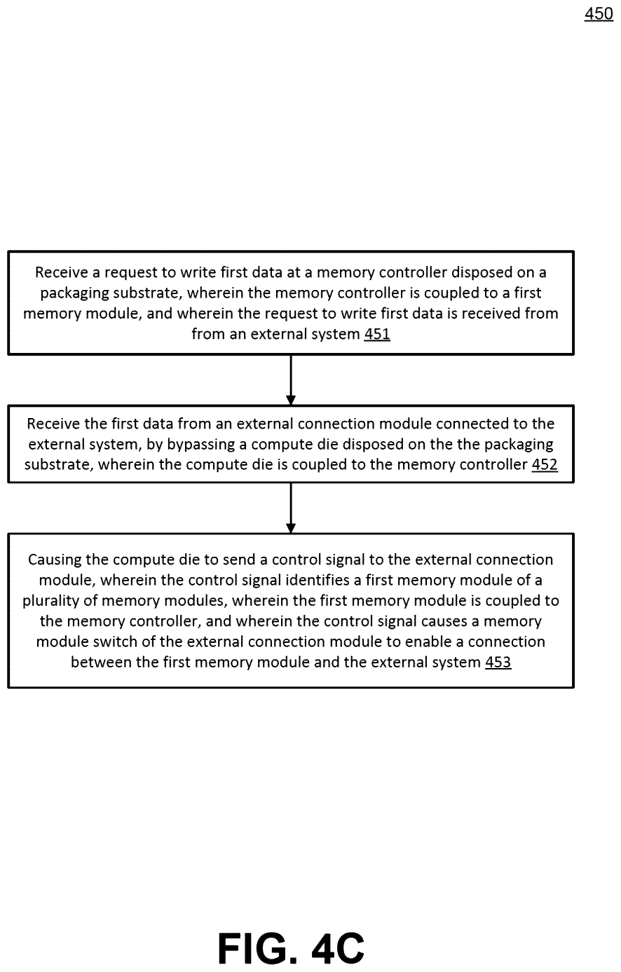

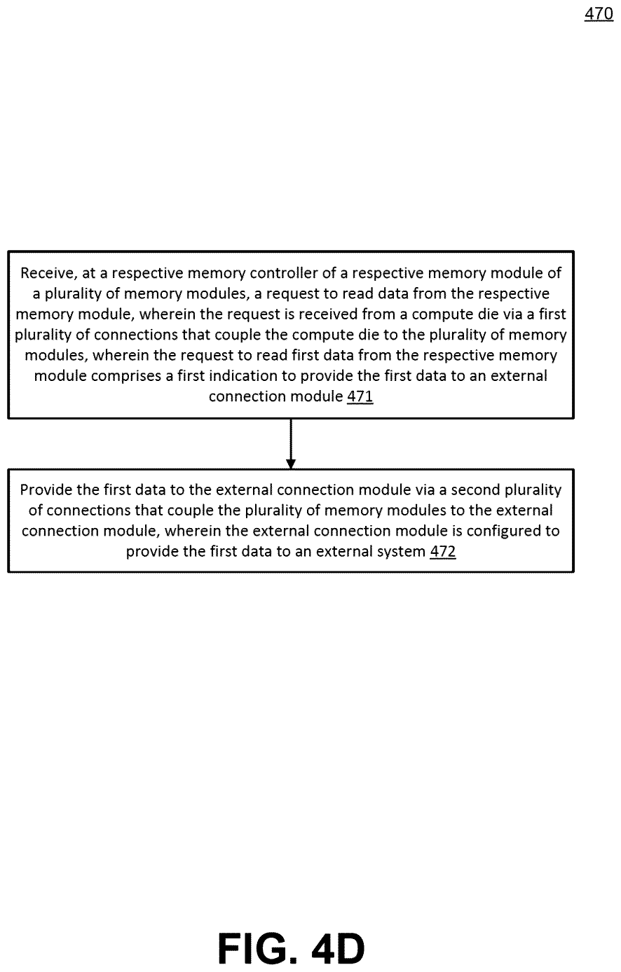

FIG. 4A is a flow chart of an example method 400 for performing direct transfer between internal memory and external memory according to some aspects of the disclosure. The method 400 may be performed by processing logic that may include hardware (e.g., one or more processing device(s), circuitry, dedicated logic, programmable logic, microcode, hardware of a device, integrated circuit, etc.), software (e.g., instructions run or executed on a processing device), or a combination thereof. In an illustrative example, the method 400 is performed by the controller 122 of FIG. 1 and/or the controller 221 of FIG. 2. In another illustrative example, the method 300 is performed by the memory sub-system controller 715 of FIG. 7. In another illustrative example, the method 400 is performed by the processing device 902 of FIG. 9. Although shown in a particular sequence or order, unless otherwise specified, the order of the operations may be modified. Thus, the illustrated implementations should be understood only as examples, and the illustrated operations may be performed in a different order, while some operations may be performed in parallel. Additionally, one or more operations may be omitted in some implementations. Thus, not all illustrated operations are required in every implementation, and other process flows are possible.

At operation 401, the processing unit performing the method 400 selects, by a multiplexer coupled between a group of non-volatile memory dies and an external interface, a first non-volatile memory die of the group of non-volatile memory dies. In some embodiments, through-silicon vias interconnect each non-volatile memory die to a respective volatile memory die of a group of volatile memory dies. In some embodiments, the non-volatile memory dies can include one or more negative-AND (NAND) dies. In some embodiments, the volatile memory dies can include one or more high-bandwidth dynamic random-access memory (DRAM) dies. In some embodiments, the processing unit includes at least one of a graphic processing unit (GPU) or a central processing unit (CPU).

At operation 402, the processing unit causes a memory controller coupled to the group of non-volatile memory dies to read a data item from the first non-volatile memory die. In some embodiments, the non-volatile memory dies, the memory controller, the processing unit, and the external interface are disposed on a common package substrate.

At operation 403, the processing unit causes the data item to be transmitted to the external interface. In some embodiments, the processing unit is utilized for training an artificial intelligence (AI) model. In such embodiments, the data item may be used or accessed by an external system as a part of the training for the AI model. In some embodiments, the processing unit is utilized for implementing an inference stage of an artificial intelligence (AI) model. In such embodiments, the data item may be used or accessed by an external system as a part of the inference stage of the AI model. For example, the data item may be a data item accessed for retrieval augmented generation (RAG) techniques, or the like.

FIG. 4B is a flow chart of an example method 420 for performing direct transfer between internal memory and external memory according to some aspects of the disclosure. The method 420 may be performed by processing logic that may include hardware (e.g., one or more processing device(s), circuitry, dedicated logic, programmable logic, microcode, hardware of a device, integrated circuit, etc.), software (e.g., instructions run or executed on a processing device), or a combination thereof. In an illustrative example, the method 420 is performed by the controller 122 of FIG. 1 and/or the controller 221 of FIG. 2. In another illustrative example, the method 420 is performed by the memory sub-system controller 715 of FIG. 7. In another illustrative example, the method 420 is performed by the processing device 902 of FIG. 9. Although shown in a particular sequence or order, unless otherwise specified, the order of the operations may be modified. Thus, the illustrated implementations should be understood only as examples, and the illustrated operations may be performed in a different order, while some operations may be performed in parallel. Additionally, one or more operations may be omitted in some implementations. Thus, not all illustrated operations are required in every implementation, and other process flows are possible.

At operation 421, the controller performing the method 420 receives a request from a compute die, at a memory controller, to read first data from a first memory die coupled to the memory controller, wherein the request comprises a first indication to provide the first data to an external interface. In some embodiments, the external interface comprises a multiplexer. In some embodiments, the multiplexer is a multiplexer. In some embodiments, the memory die includes one or more volatile memory dies and one or more non-volatile memory dies. In some embodiments, the memory die includes a high-bandwidth memory (HBM) die. In some embodiments, the data stored at the first memory die has a particular data type (also referred to herein as “data structure,” or “structure of the data”). The particular data type can be a data type for the compute device. That is, a data type that is optimized for processing by the compute die of the compute device.

At operation 422, the controller provides the first data to the external interface by bypassing the compute die, wherein the external interface is configured to provide the first data to an external system. In some embodiments, the external interface includes a communication logic block. The communication logic block is configured to package the first data based on one or more communication standards for a connection between the external interface of the compute device and the external system. In some embodiments, the communication standards include one or more of peripheral component interconnect express (PCIe), compute express link (CXL), serial advanced technology attachment (SATA), non-volatile memory express (NVMe), universal flash storage (UFS), embedded multimedia card (eMMC), universal serial bus (USB), ethernet, Nvidia Link (NVLink), or the like.

At operation 423, the controller causes the compute die to send a control signal to a multiplexer. The control signal can identify the first memory die of a plurality of memory dies. In some embodiments, the control signal causes the multiplexer to enable a connection between the first memory die and the external interface. In some embodiments, the control signal causes the multiplexer to enable a connection between the first memory die and the external system.

FIG. 4C is a flow chart of an example method 450 for performing direct transfer between internal memory and external memory according to some aspects of the disclosure. The method 450 may be performed by processing logic that may include hardware (e.g., one or more processing device(s), circuitry, dedicated logic, programmable logic, microcode, hardware of a device, integrated circuit, etc.), software (e.g., instructions run or executed on a processing device), or a combination thereof. In an illustrative example, the method 450 is performed by the controller 122 of FIG. 1 and/or the controller 221 of FIG. 2. In another illustrative example, the method 450 is performed by the memory sub-system controller 715 of FIG. 7. In another illustrative example, the method 450 is performed by the processing device 902 of FIG. 9. Although shown in a particular sequence or order, unless otherwise specified, the order of the operations may be modified. Thus, the illustrated implementations should be understood only as examples, and the illustrated operations may be performed in a different order, while some operations may be performed in parallel. Additionally, one or more operations may be omitted in some implementations. Thus, not all illustrated operations are required in every implementation, and other process flows are possible.

At operation 451, the controller processing the method 450 receives a request to write first data at a memory controller disposed on a packaging substrate, wherein the memory controller is coupled to a first memory die, and wherein the request to write first data is received from an external system.

At operation 452, the controller receives the first data from an external interface connected to the external system, by bypassing a compute die disposed on the packaging substrate, wherein the compute die is coupled to the memory controller.

At operation 453, the controller causes the compute die to send a control signal to the external interface. The control signal can identify a first memory die and can causes a multiplexer of the external interface to enable a connection between the first memory die and the external system.

FIG. 4D is a flow chart of an example method 470 for performing direct transfer between internal memory and external memory according to some aspects of the disclosure. The method 470 may be performed by processing logic that may include hardware (e.g., one or more processing device(s), circuitry, dedicated logic, programmable logic, microcode, hardware of a device, integrated circuit, etc.), software (e.g., instructions run or executed on a processing device), or a combination thereof. In an illustrative example, the method 400 is performed by the controller 122 of FIG. 1 and/or the controller 221 of FIG. 2. In another illustrative example, the method 470 is performed by the memory sub-system controller 715 of FIG. 7. In another illustrative example, the method 470 is performed by the processing device 902 of FIG. 9. Although shown in a particular sequence or order, unless otherwise specified, the order of the operations may be modified. Thus, the illustrated implementations should be understood only as examples, and the illustrated operations may be performed in a different order, while some operations may be performed in parallel. Additionally, one or more operations may be omitted in some implementations. Thus, not all illustrated operations are required in every implementation, and other process flows are possible.

At operation 471, the controller processing the method 470 receives, at a respective memory controller of a respective memory die among multiple memory dies, a request to read data from the respective memory die. The request can be received from a compute die via first connections that couple the compute die to the memory dies. The request to read first data from the respective memory die can include an indication to provide the first data to a external interface.

At operation 472, the controller provides the first data to the external interface via second of connections. The second connections couple the memory dies to the external interface. The external interface can be configured to provide the first data to an external system.

FIG. 5A shows an example high-level component diagram of a hybrid NVM/HBM device implemented in accordance with aspects of the present disclosure. As schematically illustrated by FIG. 5A, the hybrid memory and compute device 500A may be implemented as an integrated circuit (IC) that includes a compute die 510, a logic die 520, one or more NVM dies 530A-530K, and one or more volatile memory (VM) dies 540A-540N, all the dies being disposed on a common package substrate 550.

Disposed on the compute die 510 are one or more processing units (e.g., one or more GPUs 512 and/or one or more CPUs 514) and their respective auxiliary circuitry, including local memory, input/output (I/O) interfaces, etc., which are omitted from FIG. 5A for clarity and conciseness. While a single compute die 510 is shown in FIG. 5A for clarity and conciseness, in various other implementations, device 500A may include two or more compute dies 510.

In some implementations, an NVM die 530 may be represented by a NAND die. In some implementations, one or more NVM dies 530 may be single-level cell (SLC) NAND dies, which exhibit better endurance and lower access latency as compared, e.g., to multiple-level cell (MLC), triple-level cell (TLC), or quad-level cell (QLC) dies. In some implementations, a VM die 540 may be represented by an HBM dynamic random-access memory (DRAM) die.

While a single logic die 520 is shown in FIG. 5A for clarity and conciseness, in various other implementations, device 500A may include two or more logic dies 520.

The stacked VM dies 540, NVM dies 530, and the logic die 520 may be interconnected by through-silicon vias (TSVs) 570A-570Z and microbumps 580A-580Y. A TSV is a high-performance interconnect technique that utilizes a vertical electrical connection (via) that passes through a silicon wafer or die. “Microbumps” are small, raised spheres which are made of a conductive material and connect a die with another die or a substrate, thus serving as conduits delivering electrical signals from one part of a chip to another.

The components disposed on the compute die 510 may communicate with the components disposed on the logic die 520, components disposed on the NVM dies 530A-530K, and/or components disposed on the VM dies 540A-540N via respective physical interfaces (PHYs) 518, 524 interconnected by the interposer 560. An interposer is an electrical interface routing electrical signals between one socket or connection and another socket or connection. Thus, the memory access requests issued by the processing units residing on the compute die 510 may be transmitted via the interposer 560 to the logic die 520.

Disposed on the logic die 520 is the controller 522 managing the NVM dies 530 and/or the VM dies 540. In some implementations, the controller 522 may implement a common logical address space for the VM dies 540A-540N and the NVM dies 530A-530K. Accordingly, the controller 522 may perform logical-to-physical (L2P) address translation based on the common logical address space.

In some implementations, no address translation (other than offsetting by a predefined value) may be required for the logical addresses that are below the upper limit of the user-addressable capacity of the VM dies 540A-540N. In other words, the logical addresses within the user-addressable capacity of the VM dies 540A-540N will directly (e.g., with an optional offset) reference respective memory locations on the VM dies 540A-540N, while the logical addresses exceeding the upper limit of the user-addressable capacity of the VM dies 540A-540N:
if LBA<=NVM Capacity then PA_{VM}=LBA+Offset
   else PA_{NVM}=L2P[LBA]
where LBA is the logical block address,
NVM Capacity is he user-addressable capacity of the VM dies 540A-540N,
PA_{VM} is the physical address of a transfer unit (TU) residing on the VM dies 540A-540N,
Offset is the optional offset to be applied to the logical addresses,
PA_{NVM} is the physical address of a TU residing on the VM dies 530A-530K,
L2P[ . . . ] is the logical-to-physical (L2P) address translation table, and
L2P[LBA] is the physical address corresponding to the specified LBA.

In an illustrative example, the total user-addressable capacity of the VM dies 540A-540N may be 40 GB, while the total user-addressable capacity of the NVM dies 530A-530K may be 128 GB. Thus, the memory access requests initiated by the compute die 510 with respect to transfer units (TUs) (such as memory pages, blocks, etc.) referenced by logical addresses below the upper limit of the user-addressable capacity of the VM dies 540A-540N may be satisfied directly via the physical interfaces 518 and 524 accessing the VM dies 540A-540N.

Conversely, memory access requests initiated by the compute die 510 with respect to TUs referenced by the logical addresses exceeding the upper limit of the user-addressable capacity of the VM dies 540A-540N may be sent to the controller 522, which may translate these logical addresses to corresponding physical addresses of TUs residing on the NVM dies 530A-530K. The address translation may be facilitated by a logical-to-physical (L2P) table, which may be indexed by the logical addresses so that each entry of the table would store a physical address corresponding to the logical address identifying the entry:
PA_{NVM}=L2P[LBA].

FIG. 5B shows another example high-level component diagram of a hybrid NVM/HBM device 500B implemented in accordance with aspects of the present disclosure. As schematically illustrated by FIG. 5B, the hybrid memory device 500B may be implemented as an integrated circuit (IC) that includes a logic die 520, one or more NVM dies 530A-530K, and one or more volatile memory (VM) dies 540A-540N, all the dies being disposed on a common package substrate 550. While a single logic die 520 is shown in FIG. 5B for clarity and conciseness, in various other implementations, device 500B may include two or more logic dies 520. The stacked VM dies 540, NVM dies 530, and the logic die 520 may be interconnected by through-silicon vias (TSVs) 570A-570Z and microbumps 580A-580Y.

Disposed on the logic die 520 is the controller 522 managing the NVM dies 530 and/or the VM dies 540. In some implementations, the controller 522 may implement a common logical address space for the VM dies 540A-540N and the NVM dies 530A-530K. Accordingly, the controller 522 may perform logical-to-physical (L2P) address translation based on the common logical address space, as described in more detail herein above.

The host system (not shown in FIG. 5B) may communicate with the components disposed on the logic die 520, components disposed on the NVM dies 530A-530K, and/or components disposed on the VM dies 540A-540N via the host interface 524. In some implementations, the host interface 524 may be represented by a logical host interface (e.g., NVMe) operating over a physical host interface (e.g., PCIe, CXL, SATA Express, etc.).

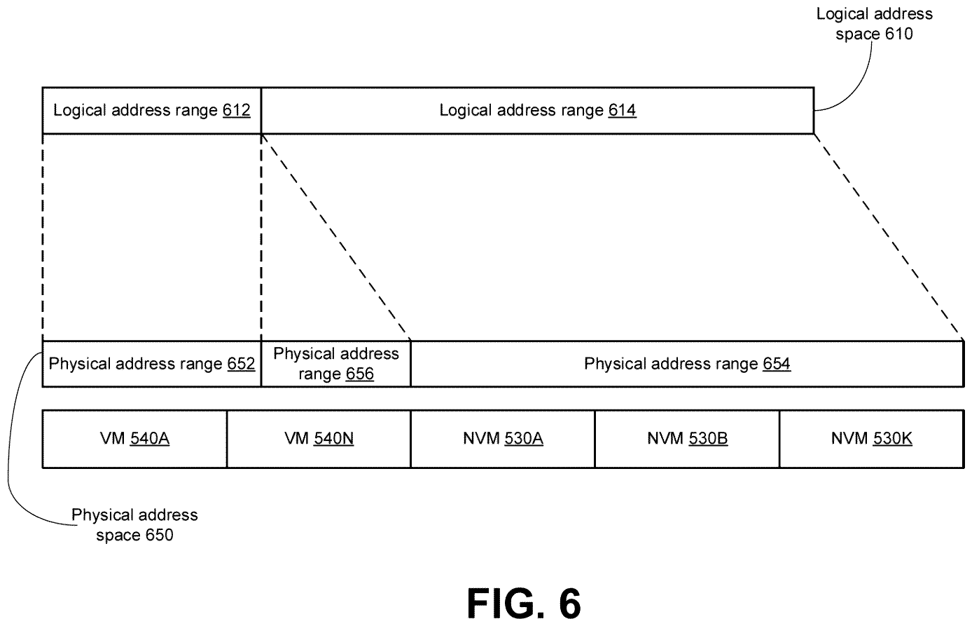

FIG. 6 schematically illustrates the example logical address space 610 and physical address space 650 of the device 500A-510B in accordance with aspects of the present disclosure. As schematically illustrated by FIG. 6, the logical address space 610 includes two logical address ranges 612 and 614.

The logical address range 612, the size of which matches the size of the user-addressable capacity of the VM dies 540A-540N, contains logical addresses that directly (e.g., with an optional offset) reference respective memory locations residing within the VM physical address range 652 corresponding to the user-addressable capacity of the VM dies 540A-540N.

The logical address range 614, residing immediately above the logical address range 612, contains logical addresses that are translatable to corresponding physical addresses identifying TUs that reside within the NVM physical address range 654 on the NVM dies 530A-530K. In some embodiments, the discussion with reference to FIG. 6 is applicable to the VM dies 140 and the NVM dies 130 of FIG. 1, where although both can be treated as on-chip cache, the VM dies 140 is faster-access cache and the NVM dies 130 is slower-access cache, and thus designed to back up the faster-access cache.

In some implementations, one or more physical address sub-ranges within the physical address ranges 652 and/or 654 may be reserved by the controller 522 for performing, e.g., various memory management and/or other system tasks. Accordingly, the size of the physical address range 652 and the size of the corresponding logical address range 612 may be less than the combined capacity of the VM dies 540A-540N. Similarly, the size of the physical address range 654 and the size of the corresponding logical address range 614 may be less than the combined capacity of the NVM dies 530A-530K.

In some implementations, content of the NVM dies 530A-530K may not be directly accessible by the processing units 512, 514 or the compute die 110 (FIG. 1). In an illustrative example, the controller 522 may reserve the capacity of the VM dies 540A-540N (or 140A-140N in FIG. 1) as fast-access cache to store certain portions (e.g., most recently accessed portions or most frequently accessed portions) of the slower-access content of the NVM dies 530A-530K (or 130A-130K of FIG. 1), although both may still be treated as the on-chip cache 121.

In operation, responsive to receiving a memory read request specifying a logical memory address to be read, the memory interface implemented by the logic die 520 may determine whether the logical memory address specified by the memory read request falls within the VM physical address range 652 corresponding to the fast-access capacity of the VM dies 540A-540N.

If the logical memory address specified by the memory read request falls within the VM physical address range 652, the memory interface implemented by the logic die 520 may read, from a volatile memory die 540A-540N, the data item stored in the location identified by the logical memory address. In some embodiments, the data item is returned to the requestor (e.g., a processing unit 512, 514 or the compute die 110) via the memory interface (e.g., the physical interfaces 518, 524).

Conversely, if the logical memory address specified by the memory read request falls outside the VM physical address range 652 and/or physical address range 656, the controller 522 may translate the logical address to a corresponding physical address within the physical address range 654 and/or 656. The controller 522 may then read the data stored at the TU (e.g., a block or a page) referenced by the physical address and return the data to the requestor (e.g., a processing unit 512, 514) via the memory interface (e.g., the physical interfaces 518, 524).

The controller 522 may determine whether the contents of the TU identified by the physical address had previously been cached in the VM dies 540A-540N (or 140A-140N of FIG. 1 of the fist-level cache 121). Should a hit occur, the read request may be satisfied from the VM dies. The contents of the identified cache line may be returned to the requestor (e.g., a processing unit 512, 514 or compute die 110) via a volatile memory interface (e.g., including the physical interfaces 518 and/or 524). In case of a miss, the controller 522 may allocate a new cache entry in the VM dies 540A-540N, read the contents of the TU identified by the physical address, store the retrieved data item in the newly allocated cache entry, and return the data item to the requestor processing unit 512, 514 via the volatile memory interface.

With additional reference to FIG. 1, in some embodiments, the on-chip cache 121 may implement the write-through policy. Accordingly, responsive to subsequently receiving a memory write request, the controller 122 or 522 may identify the cache entry whose tag matches the physical address corresponding to the logical address specified by the request. The controller 122 or 522 may store the data item specified by the memory request to the identified cache entry. The controller 122 or 522 may then store the content of the cache entry to the TU identified by the physical address. In various use cases, the compute device 102 or the compute device 500A, 500B may be employed for both training and inference stages of AI models, such as large language models (LLMs), generative transformer models, etc.

In an illustrative example, the hybrid memory and the compute die 110, or hybrid memory and the compute device 500A, and/or the hybrid memory device 500B may be utilized for training of an artificial intelligence (AI) model. In another illustrative example, the compute device 102 and/or the hybrid memory devices 500A-500B may be utilized for implementing an inference stage of an artificial intelligence (AI) model.

In an illustrative example, training an AI model involves the need of storing and frequently accessing or modifying large amounts of data, including model states, weights, parameters, etc. This need can be effectively addressed by the compute device 102, the hybrid memory and compute device 500A, and/or the hybrid memory device 500B, which significantly increases the size of the local memory co-located with one or more processing units or the compute die 110.

In another illustrative example, performing an inference by an AI model involves handling a very large size of the model context, which requires the memory capacity that may exceed that of currently available solutions. This requirement is effectively met by the compute device 102, the hybrid memory and compute device 500A, and/or the hybrid memory device 500B, which can significantly increase the size of the local memory co-located with one or more processing units or the compute die 110.

FIG. 7 illustrates a high-level component diagram of an example computing system 700 that includes a memory sub-system 710 in accordance with some implementations of the present disclosure. The memory sub-system 710 can include one or more memory devices 730A-730N, which may include one or more volatile memory devices, and/or one or more non-volatile memory devices. In an illustrative example, one or more memory devices 730A-730N may be represented by the compute device 102 or hybrid NVM/HBM devices 500A and/or 500B.

The memory sub-system 710 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 700 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 700 can include a host system 720 that is coupled to one or more memory sub-systems 710. In some implementations, the host system 720 is coupled to different types of memory sub-system 710. FIG. 7 illustrates one example of a host system 720 coupled to one memory sub-system 710. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 720 can include a processor chipset and a software stack executed by the processor chipset. The processor chipset can include one or more cores, one or more caches, a memory controller (e.g., NVDIMM controller), and a storage protocol controller (e.g., PCIe controller, SATA controller, CXL controller). The host system 720 uses the memory sub-system 710, for example, to write data to the memory sub-system 710 and read data from the memory sub-system 710.

The host system 720 can be coupled to the memory sub-system 710 via a physical host interface. Examples of physical host interfaces include a serial advanced technology attachment (SATA) interface, a compute express link (CXL) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 720 and the memory sub-system 710. The host system 720 can further utilize an NVM Express (NVMe) interface to access the memory components (e.g., the one or more memory device(s) 730A-730N) when the memory sub-system 710 is coupled with the host system 720 by the physical host interface (e.g., PCIe or CXL bus). The physical host interface can provide an interface for passing control, address, data, and other signals between the memory sub-system 710 and the host system 720. FIG. 7 illustrates a memory sub-system 710 as an example. In general, the host system 720 can access multiple memory sub-systems via a same communication connection, multiple separate communication connections, and/or a combination of communication connections.

The memory devices 730A-730N can include any combination of the different types of non-volatile memory devices and/or volatile memory devices. In an illustrative example, one or more memory devices 730A-730N may be represented by the compute device 102 or by the hybrid NVM/HBM devices 500A and/or 500B.

The volatile memory devices can be, e.g., random access memory (RAM), such as dynamic random access memory (DRAM) and synchronous dynamic random access memory (SDRAM). Some examples of non-volatile memory devices include negative-and (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

A memory device 730A-730N can include one or more arrays of memory cells. One type of memory cell, for example, single level cells (SLC) can store one bit per cell. Other types of memory cells, such as multi-level cells (MLCs), triple level cells (TLCs), and quad-level cells (QLCs), can store multiple bits per cell. In some implementations, each of the memory devices 730A-730N can include one or more arrays of memory cells such as SLCs, MLCs, TLCs, QLCs, or any combination of such. In some implementations, a particular memory device can include an SLC portion, and an MLC portion, a TLC portion, or a QLC portion of memory cells. The memory cells of the memory devices 730A-730N can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory devices 730A-730N can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, electrically erasable programmable read-only memory (EEPROM).

A memory sub-system controller 715 can communicate with the memory device(s) 730A-730N to perform operations such as reading data, writing data, or erasing data at the memory devices 730A-730N and other such operations. The memory sub-system controller 715 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 715 can be a microcontroller, special purpose logic circuitry (e.g., a field programmable gate array (FPGA), an application specific integrated circuit (ASIC), etc.), or other suitable processor.

The memory sub-system controller 715 can include a processor 717 (e.g., a processing device) configured to execute instructions stored in a local memory 719. In the illustrated example, the local memory 719 of the memory sub-system controller 715 includes an embedded memory configured to store instructions for performing various processes, operations, logic flows, and routines that control operation of the memory sub-system 710, including handling communications between the memory sub-system 710 and the host system 720.

In some implementations, the local memory 719 can include memory registers storing memory pointers, fetched data, etc. The local memory 719 can also include read-only memory (ROM) for storing micro-code. While the example memory sub-system 710 in FIG. 7 has been illustrated as including the memory sub-system controller 715, in another implementation of the present disclosure, a memory sub-system 710 does not include a memory sub-system controller 715, and can instead rely upon external control (e.g., provided by an external host, or by a processor or controller separate from the memory sub-system).

In general, the memory sub-system controller 715 can receive commands or operations from the host system 720 and can convert the commands or operations into instructions or appropriate commands to achieve the desired access to the memory device(s) 730A-730N. The memory sub-system controller 715 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory device(s) 730A-730N. The memory sub-system controller 715 can further include host interface circuitry to communicate with the host system 720 via the physical host interface. The host interface circuitry can convert the commands received from the host system into command instructions to access the memory device(s) 730A-730N as well as convert responses associated with the memory device(s) 730A-730N into information for the host system 720.

The memory sub-system 710 can also include additional circuitry or components that are not illustrated. In some implementations, the memory sub-system 710 can include a cache or buffer (e.g., DRAM) and address circuitry (e.g., a row decoder and a column decoder) that can receive an address from the memory sub-system controller 715 and decode the address to access the memory device(s) 730A-730N.

In some implementations, the memory device(s) 730A-730N include local media controllers 735 that operate in conjunction with memory sub-system controller 715 to execute operations on one or more memory cells of the memory device(s) 730A-730N. An external controller (e.g., memory sub-system controller 715) can externally manage the memory device 730A-730N (e.g., perform media management operations on the memory device(s) 730A-730N). In some implementations, a memory device 730A-730N is a managed memory device, which is a raw memory device (e.g., memory array 704) having control logic (e.g., local controller 735) for media management within the same memory device package. An example of a managed memory device is a managed NAND (MNAND) device. Memory device(s) 730A-730N, for example, can each represent a single die having some control logic (e.g., local media controller 735) embodied thereon. In some implementations, the local media controller 735 may be represented by the controller 122 of FIG. 1 or the controller 522 of FIGS. 5A-5B.

In some implementations, the memory sub-system 710 includes a memory interface 713 that is responsible for handling interactions of memory sub-system controller 715 with the memory devices of memory sub-system 710, such as memory devices 730A-730N. For example, the memory interface 713 can send or transmit memory access commands corresponding to requests received from host system 720 to memory devices 730A-730N, such as program commands, read commands, or other commands. In addition, the memory interface 713 can receive data from devices 730A-730N, such as data retrieved in response to a read command or a confirmation that a program command was successfully performed. In some implementations, the memory sub-system controller 715 includes at least a portion of the memory interface 713. For example, the memory sub-system controller 715 can include a processor 717 (processing device) configured to execute instructions stored in local memory 719 for performing the operations described herein.

In some implementations, the host system 720 implements an ML/AI framework 750. ML/AI framework 750 can include one or more ML models, a processing engine, and a training engine, among other components, which can be used to perform any automated task (e.g., classify or categorize documents or images). In order to train the one or more ML models, ML/AI framework 750 can issue requests to read the training data, which may be stored on one or more memory devices 730A-730N, and process the training data accordingly. In some implementations, ML/AI framework 750 is executed by multiple processing units (e.g., GPUs and/or CPUs) which can process many threads/streams in parallel.

In some implementations, host system 720 could include hundreds of parallel processing threads that can request and process different subsets of the training data concurrently. In some implementations, at least some of the processing tasks of the ML/AI framework 750 are performed by the compute die 110 of the compute device 102 (FIG. 1) or by the processing units 512, 514 residing on the hybrid memory device 500A of FIG. 5A. In embodiments, one or more of the compute device 102 or the hybrid memory devices 500A are employed by the memory sub-system as memory devices 730A-730N.

Once a certain amount of training is complete, ML/AI framework 750 can enter an inference phase to analyze different input data. The input data can similarly be stored on memory device 102 of the same or a different memory sub-system 710. In some implementations, ML/AI framework 750 can issue requests to read the input data from memory sub-system 710 and store a copy of the input data in the host memory 722.

In some implementations, the host system 720 utilizes a set of queues to track the memory access commands issued to the memory sub-system 710 (e.g., requests to read data for ML/AI framework 750). For example, the host system 720 can include a number of submission queues, storing submission queue entries representing the memory access commands issued to the memory sub-system 710, and a number of completion queues, storing completion queue entries received from the memory sub-system 710 to indicate that the corresponding memory access commands have been executed. In some implementations, the host system 720 can maintain these queues in the host memory 722.

The host memory 722 may include one or more DRAM devices, HBM devices, and/or other types of memory devices. In some implementations, the host memory 722 includes the compute device 102 or one of the hybrid HBM/NVM memory devices 500A and/or 500B of FIGS. 5A-5B.

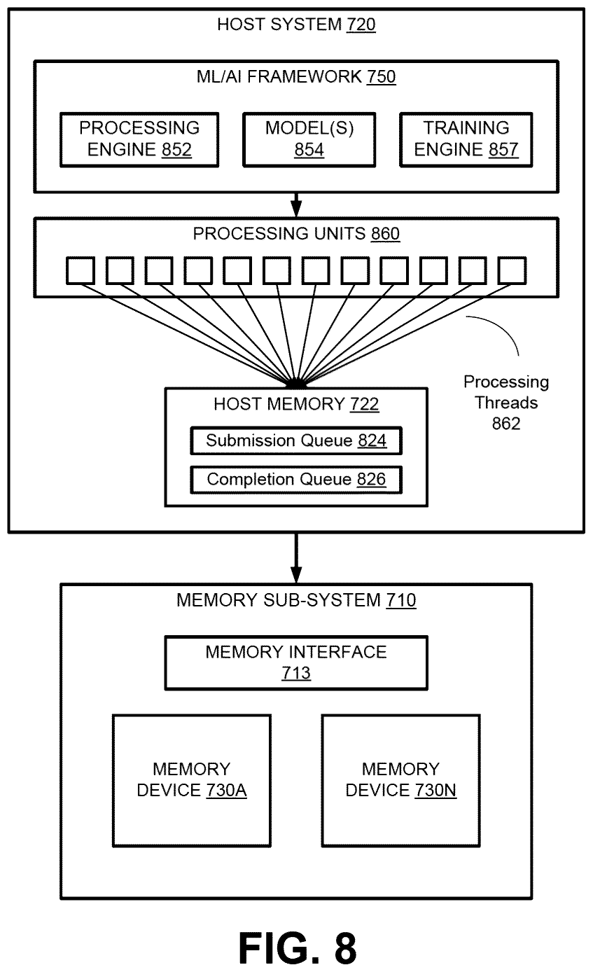

FIG. 8 is a block diagram illustrating a system for performing AI model inference operations using memory devices and/or host systems implemented in accordance with aspects of the present disclosure. As illustrated, host system 720 includes ML/AI framework 750 which can be executed by a number of processing threads 862. Host system 720 further includes host memory 722, including submission queues 824 and completion queues 826. In some implementations, ML/AI framework 750 includes a processing engine 852, one or more machine learning models 854, and a training engine 857, among other components, which can be used to perform any automated task (e.g., classify or categorize documents or images). Depending on the implementation one or more components that make up ML/AI framework 750 can be distributed across multiple different computing devices (e.g., host computers, servers, etc.). In some implementations, processing engine 852 may use a set of trained machine learning models 854 that are trained and used to perform any number of automated operations. The processing engine 852 may also preprocess any received input data prior to using the data for training of the set of machine learning models 854 and/or applying the set of trained machine learning models 854 to the input data. Based on the output of the set of trained machine learning models 854, the processing engine 852 may obtain, for example, a classification and/or category of the input data, as well an assessment of the classification.

In some implementations, at least some of the processing tasks of the ML/AI framework 750 are performed by the compute die 110 residing on the compute device 102 of FIG. 1 or by processing units 512, 514 residing on the compute die 510 of a hybrid memory device 500A of FIG. 5A. In embodiments, the compute device 102 or one or more hybrid memory devices 500A are employed by the memory sub-system as memory devices 730A-630N.

The set of machine learning models 854 may refer to model artifacts that are created by the training engine 857 using training data that includes training inputs and corresponding target outputs (i.e., correct answers for respective training inputs). During training, patterns in the training data that map the training input to the target output (i.e., the answer to be predicted) can be found, and are subsequently used by the machine learning models 854 for future predictions. Depending on the implementation, the set of machine learning models 854 may be composed of, for example, a single level of linear or non-linear operations (e.g., a support vector machine [SVM]) or may be a deep network, (i.e., a machine learning model that is composed of multiple levels of non-linear operations). Examples of deep networks are neural networks including convolutional neural networks, recurrent neural networks with one or more hidden layers, and fully connected neural networks.

Thus, in order to train and utilize the one or more machine learning models 854, ML/AI framework 750 can issue requests to read training data and input data, which may be stored on memory device 102 of memory sub-system 710, and process the data accordingly. In some implementations, these memory access requests are sent by the parallel processing threads 862 being executed by respective processing units 860. The processing units 860 can include a number of general-purpose processing devices such as microprocessors, central processing units (CPUs), or the like, or more specialized processing devices, such as graphics processing units (GPUs), which may be optimized for performing high-speed sequential processing operations. Thus, at least some of the processing units 860 may be the compute device 102 of FIG. 1.

Depending on the implementation there can be any number of processing units 860 (e.g., tens or hundreds), each executing a respective one or more of the processing threads 862. Each processing thread 862 represents a series of sequential operations directed to memory sub-system 710 (e.g., read requests for separate segments of an element of training or input data stored at memory sub-system 710). Due to the large relative size of the training data or input data, each element may be broken up into separate segments of a smaller fixed size and stored at sequential memory addresses in memory sub-system 710. Thus, in order to read the entire element of data, a sequence of multiple read requests can be issued to obtain all of the separate segments. Each processing thread 862 can include a series of read requests to read the segments of a different element of data from memory sub-system 710. Upon the read requests from each processing thread 862 being generated, the requests can be stored as entries in one of submission queues 824, from which they can be issued to memory sub-system 710. Received responses to the requests from memory sub-system 710 can be stored as entries in one of completion queues 826, retrieved by processing threads 862 and provided to ML/AI framework 750 for execution in either a training phase or an inference phase.

FIG. 9 illustrates an example machine of a computer system 900 within which a set of instructions, for causing the machine to perform any one or more of the methodologies discussed herein, can be executed. In some implementations, the computer system 900 can correspond to a host system (e.g., the host system 720 of FIG. 7) that includes, is coupled to, or utilizes a memory sub-system (e.g., the memory sub-system 710 of FIG. 7) or can be used to perform the operations of a controller (e.g., to execute an operating system to perform operations corresponding to the memory interface 713 or memory sub-system controller 715 of FIG. 7). In alternative implementations, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 900 includes a processing device 902, a main memory 904 (e.g., read-only memory (ROM), flash memory, dynamic random access memory (DRAM) such as synchronous DRAM (SDRAM) or Rambus DRAM (RDRAM), etc.), a static memory 906 (e.g., flash memory, static random access memory (SRAM), etc.), and a data storage system 918, which communicate with each other via a bus 930.

Processing device 902 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 902 can also be one or more special-purpose processing devices such as an application specific integrated circuit (ASIC), a field programmable gate array (FPGA), a digital signal processor (DSP), network processor, or the like. The processing device 902 is configured to execute instructions 928 for performing the operations and steps discussed herein. The computer system 900 can further include a network interface device 908 to communicate over the network 920.

The data storage system 918 can include a machine-readable storage medium 924 (also known as non-transitory computer-readable storage medium) on which is stored one or more sets of instructions 928 (executable instructions) or software embodying any one or more of the methodologies or functions described herein. The instructions 928 can also reside, completely or at least partially, within the main memory 904 and/or within the processing device 902 during execution thereof by the computer system 900, the main memory 904 and the processing device 902 also constituting machine-readable storage media. The machine-readable storage medium 924, data storage system 918, and/or main memory 904 can correspond to the memory sub-system 710 of FIG. 7. In some implementations, the data storage system 918 may include the compute device 102 or one or more hybrid HBM/NVM memory devices 500A and/or 500B of FIGS. 5A-5B.

In some implementations, the instructions 928 include instructions to implement functionality corresponding to the memory interface 713 of FIG. 7). While the machine-readable storage medium 924 is shown in an example implementation to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some implementations, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, implementations of the disclosure have been described with reference to specific example implementations thereof. It will be evident that various modifications can be made thereto without departing from the broader spirit and scope of implementations of the disclosure as set forth in the following claims. The specification and drawings are, accordingly, to be regarded in an illustrative sense rather than a restrictive sense.

What is claimed is:

1. A device, comprising:
a plurality of non-volatile memory dies;
a memory controller coupled to the plurality of non-volatile memory dies;
a processing unit coupled to the memory controller and the plurality of non-volatile memory dies;
an external interface coupled, via a multiplexer controlled by the processing unit, to the plurality of non-volatile memory dies;
wherein the processing unit is configured to perform operations, comprising:
selecting, by the multiplexer, a first non-volatile memory die of the plurality of non-volatile memory dies;
causing the memory controller to read a data item from the first non-volatile memory die; and
causing the data item to be transmitted via the external interface.

2. The device of claim 1 further comprising:
a plurality of volatile memory dies; and
a plurality of through-silicon vias interconnecting each volatile memory die of the plurality of volatile memory dies to a respective non-volatile memory die of the plurality of non-volatile memory dies.

3. The device of claim 2, wherein the plurality of volatile memory dies comprise one or more high-bandwidth dynamic random-access memory (DRAM) dies.

4. The device of claim 1, wherein the plurality of non-volatile memory dies comprise one or more negative-AND (NAND) dies.

5. The device of claim 1, wherein the processing unit comprises at least one of: a graphic processing unit (GPU) or a central processing unit (CPU).

6. The device of claim 1, wherein the plurality of non-volatile memory dies, the memory controller, the processing unit, and the external interface are disposed on a common package substrate.

7. The device of claim 1, wherein the processing unit is utilized for training an artificial intelligence (AI) model.

8. The device of claim 1, wherein the processing unit is utilized for implementing an inference stage of an artificial intelligence (AI) model.

9. A method comprising:
selecting, by a multiplexer coupled to a plurality of non-volatile memory dies and to an external interface, a first non-volatile memory die of the plurality of non-volatile memory dies;
causing a memory controller coupled to the plurality of non-volatile memory dies to read a data item from the first non-volatile memory die; and
causing the data item to be transmitted to the external interface.

10. The method of claim 9, wherein a plurality of through-silicon vias interconnect each non-volatile memory die of the plurality of non-volatile memory dies to a respective volatile memory die of a plurality of volatile memory dies.

11. The method of claim 9, wherein the plurality of volatile memory dies comprise one or more high-bandwidth dynamic random-access memory (DRAM) dies.

12. The method of claim 9, wherein the plurality of non-volatile memory dies comprises one or more negative-AND (NAND) dies.

13. The method of claim 9, wherein the plurality of non-volatile memory dies, the memory controller, the multiplexer, the external interface, and a processing unit coupled to the non-volatile memory dies and the multiplexer, are disposed on a common package substrate.

14. The method of claim 9, wherein the data item is utilized for training an artificial intelligence (AI) model.

15. The method of claim 9, wherein the data item is utilized for implementing an inference stage of an artificial intelligence (AI) model.

16. A non-transitory computer-readable storage medium comprising instructions, that when executed by a controller, cause the controller to perform operations comprising:
selecting, by a multiplexer coupled between a plurality of non-volatile memory dies and an external interface, a first non-volatile memory die of the plurality of non-volatile memory dies;
causing a memory controller coupled to the plurality of non-volatile memory dies to read a data item from the first non-volatile memory die; and
causing the data item to be transmitted to the external interface.

17. The non-transitory computer-readable storage medium of claim 16, wherein a plurality of through-silicon vias interconnect each non-volatile memory die of the plurality of non-volatile memory dies to a respective volatile memory die of a plurality of volatile memory dies.

18. The non-transitory computer-readable storage medium of claim 17, wherein the plurality of volatile memory dies comprise one or more high-bandwidth dynamic random-access memory (DRAM) dies.

19. The non-transitory computer-readable storage medium of claim 16, wherein the plurality of non-volatile memory dies comprises one or more negative-AND (NAND) dies.

20. The non-transitory computer-readable storage medium of claim 16, wherein the plurality of non-volatile memory dies, the memory controller, the multiplexer, the external interface, and a processing unit coupled to the non-volatile memory dies and the multiplexer, are disposed on a common package substrate.
